(19) United States
(12) Patent Application Publication
(10) Pub. No.: US 2003/0178805 A1
(43) Pub. Date: Sep. 25, 2003

(54) Interlocking-tube variable-length two-piece vehicular side, or nerf, bars

(76) Inventor: Jerry Michael Elrod, Glendale, AZ (US)

Correspondence Address: FUESS & DAVIDENAS, Suite II-G, 10951 Sorrento Valley Road, San Diego, CA, 92121-1613, US

(21) Appl. No.: 10/106,932

(22) Filed: Mar. 25, 2002

(51) Int. Cl. B60R 3/00

(52) U.S. Cl. 280/163; 296/163

(57) ABSTRACT

A selected-length first, preferably tubular, rear member substantially subtending a side region of a vehicle just to the fore of the vehicle's rear wheel well has when mounted to the vehicle an integral extension that slides within, and strongly engages, another selected-length, forward, member that substantially subtends the remaining side region of the vehicle, extending so far as the vehicle's front wheel well. The two members together as are (i) individually selected in length, and (ii) slid together to a variable extent, jointly form a two-piece vehicular side, or nerf, bar that is precisely sized to the vehicle to which it is applied, strong, and suitably shipped by conventional land and air freight carriers. Lower levels of inventory are thus required to suit a wide range of vehicular applications.

### BACKGROUND OF THE INVENTION

1. Field of the Invention

The present invention generally concerns running boards and side, or nerf, bars for vehicles, normally pickup trucks and sport utility vehicles.

The present invention particularly concerns vehicular side, or nerf, bars that are any of (i) multiple piece interlocking, (ii) tubular interlocking, and/or (iii) variable length.

2. Description of the Prior Art

The most relevant prior art to the multi-piece vehicular side, or nerf, bars of the present invention are (i) vehicular running boards and (ii) single-piece side, or nerf, bars.

2.1 Running Boards

Running boards are normally placed on tough duty vehicles such as pickup trucks and sport utility vehicles, and are themselves substantial and durable items.

Running boards are typically constructed of metal with a bright, matte or black weatherproof finish. They are most commonly constructed of 0.075-0.080 gauge sheet steel, with a width of about 6½″ and a length sufficient to extend alongside the cab, or both the cab and box, regions of a pickup truck. The flat upper surface is normally welded or stamped to present downwards extending peripheral flanges, or lips.

The running board fastens to the underside of the truck via brackets, bolts and nuts. The substantial portion of all brackets, and all fasteners, are normally concealed.

In use the running boards present a wide anti-skid step by which entrance may be had from ground level into the cab of the truck. The also offer mechanical protection to the sides of a vehicle on which they are installed.

Running boards may be lighted or non-lighted.

Certain running boards may be custom styled.

Running boards are commonly available for pickups in both cab and full lengths in both one or two piece forms.

For pickup trucks in particular, an extensive array of different size running boards is offered for sale as fit the trucks with standard, crew and extended cabs of different manufacturers.

The appropriate length and part number of a running board suitable to a particular vehicle is a function of the make, model, year, type and even style of the vehicle. Some of the larger manufacturers of running boards carry inventories of scores of different running boards.

Most single piece running boards are too large to be sent by normal surface truck—such as United Parcel Service—or air—such as Federal Express—transport, and are commonly transported by rail.

Two piece running boards are known. However, two piece running boards suffer from diminished structural strength in that the forward and rear pieces are not intended to be connected to each other, and thus each piece require a separate suspension at the point of its most proximate contact to the other piece, normally along a line perpendicular to the side of a pickup truck located approximately where the cab of the pickup truck meets the bed of the pickup truck. The reason why this is so, and why forward and rear pieces of a two piece running board are not connected, is because of (i) the rigidity of the downward-extending flanges versus (ii) the inevitable longitudinal flex, and the flex axis, of the truck and its frame. The chassis stiffness of the truck cannot prevent some flexure between its cab and its bed regions at least some conditions of load, speed and terrain—which is exactly why a bed of a pickup truck is not integrally formed with the cab. If a side-mounted running board—which is structurally insubstantial relative to the steel frame of the truck—was to attempt to resist this flexure in and across a narrow, (e.g., 6½″) short (e.g., 1″) flanges that were welded or bolted into immovability, then these flanges will simply crack. Accordingly, two piece running boards teach away from connecting the two pieces of the running board.

2.2 Side, or Nerf, Bars

Side, or nerf, bars are commonly made from round steel tube, most commonly of 3+″ diameter.

They may be fashioned with or without a step of their top surface. They are normally fashioned so as to have, or receive, a step surface by which human entrance into the truck is abetted.

Drilling of the side bar and/or its support brackets and/or the truck is normally required for mounting of the side bar.

Various finishes are offered including chrome and powder coated (black).

Like running boards, side, or nerf, bars are commonly available for pickups in cab length and full length, although, to the best knowledge of the inventor, only in single piece form.

For pickup trucks in particular, this creates an extensive array of different sizes as fit trucks with standard, crew and extended cabs from different manufacturers. The appropriate length and part number of a running board suitable to a particular vehicle is a function of the make, model, year, type and even style of the vehicle. Some of the larger manufacturers of side bars carry inventories of many scores of different side bars.

As with single piece running boards, single piece side bars are too large to be sent by normal surface truck—such as United Parcel Service—or air—such as Federal Express—transport, and are commonly transported by rail.

To offset the requirement to stock a bewildering number of different side bars for different vehicles, side bars in several “universal sizes” are offered. One approximate 48′ size is offered in larger diameters for full size trucks while an equal length, 48″, side bar of a lessor diameter is offered for mini pickup. The universal sizes extend upwards from this length, with lengths of 60″, 72″, 78″ and 90″ being most common.

Alas, when the manufacturer designs a vehicle it is seldom, and is most likely never, concerned with making the separation between the front and the rear wheel wells to be an integral number of inches, let alone to be 60″, 72″, 78″ or 90″ inches, exactly. Accordingly, universal side bars seldom fit properly. Besides aesthetic impairment, the poor fit reduces mounted strength, which impedes the whole function of the side bars in the first place.

It would accordingly be useful if some way could be found to make multi-piece side bars—with their prospective advantages in both (i) shipping, and (ii) fit, where the multiple pieces could be matched for the application to hand—and could thus connect more suitably to vehicles—while avoiding breakage due to normal flexing.

### SUMMARY OF THE INVENTION

The present invention contemplates vehicular side, or nerf, bars that are any, and each, of (i) multiple-, normally two-, piece interlocking, (ii) tubular, and/or (iii) variable in length.

Each vehicular side bar of a most preferred embodiment consists of two tubular members—one of which substantially subtends the forward side region of the vehicle and the other of which substantially subtends the rearward side region of the vehicle between the vehicle's two side wheel wells—that slide within one another to produce, when both assembled and mounted to both the vehicle and to each other, a complete side bar to, and fitting, the vehicle.

Many advantages are gained by the two or more piece construction.

Each piece is commonly sufficiently short—preferably less than sixty (60) inches maximum, and permissively still shorter—so as to be conveniently and economically transported—in shipments of even so little as one single piece—by surface truck or by air.

Various configurations of vehicles such as, by way of example, the standard and crew and extended cab versions of the pickups of various major manufacturers can all be accommodated by judicious selection of an appropriate-length forward piece to be slidingly joined with an appropriate-length rearward piece. Each piece need not be of exact length, but can most commonly be several inches longer or shorter than would precisely match the corresponding the length of a forward or rearward region of vehicle to which the piece will be fitted so long as, when each piece is used in concert with the other, the two pieces together can be (i) slid in separation to match the exact correct length for the vehicle while (ii) retaining sufficient sliding overlap each piece to the other.

The joint between the preferably two, preferably tubular, sections is not particularly noticeable—especially when the entire exterior surface (ex of foot step areas) of each side bar piece is chromed, as is common. The two pieces of the side bar are preferably strongly affixed to each other, preferably by a nut and bolt wherein the nut is commonly captive, and welded to the interior of the lessor diameter piece. The two-piece side bar is commonly strong, and strongly mounted. It appears as a quality custom-length side bar with all step surfaces, if present, located in the proper places. For example, for stretch or crew cabs having an auxiliary second door on but only one side of the vehicle, by proper selection of pieces (here the rear, or bed, side piece) the side bars on each side can be appropriate to that side only, and will not be a mirror image of the other side.

Stocking requirements are thereby reduced: a reduced overall number of different-length pieces being suitably selected and joined to fit almost all vehicles.

Because of their preferred sliding engagement, the preferred tubes are, when assembled to each other, of considerable joint strength, producing a side bar that is strong to protect the vehicle, and to support the weight of anyone who may stand upon it.

The preferred sliding tubes are preferably of tight tolerance between the interior diameter of one in regions where it receives the exterior diameter of the other, thus producing a smooth and nearly featureless external “seam” that insignificantly collects road salt and dirt, and corrodes, relatively to this region on two-piece running boards of the prior art.

1. A Two-Piece Side Bar

Accordingly, in one of its aspects the present invention is embodied in a vehicle side bar having two or more interlocking pieces.

Each of the interlocking pieces is preferably tubular, and these tubular pieces are preferably interlock one to the next by action of an end of one tube sliding into an open end of another tube.

The vehicle side bar may be adapted for a pickup truck having a cab region and a bed region where (i) a first interlocking piece extends the along the cab region of the pickup truck, (ii) a second interlocking piece extends the along the bed region of the pickup truck, (iii) the first piece interlocking to the second piece substantially where the cab of the pickup truck meets the bed of the pickup truck.

2. A Side Bar Having Elongate Hollow Pieces that Slide Together

In another of its aspects the present invention is embodied in a side bar for a vehicle which side bar has two or more elongate hollow pieces that, by virtue of an end region of one piece sliding within an end region of another piece to a variable extent, extend when slidingly mated one to another for a variable distance along a side of the vehicle. The multiple-piece side bar is thus adjustable in length.

3. A Side Bar Kit

In yet another of its aspects the present invention is embodied in a user-specified and user-installable kit for mounting a side bar of proper length to and along a full side of a vehicle having both a forward side region and a rear side region between two same-side wheel wells.

The kit includes (i) a first piece selected in accordance with the vehicle from among a plurality of first-type pieces of various lengths that are variously suitable to substantially span forward side regions of various different vehicles, (ii) a second piece, also selected in accordance with the vehicle, from among a plurality of second-type pieces of various lengths that are variously suitable to substantially span rear side regions of various different vehicles, and (iii) mounting brackets and attaching hardware sufficient not only to mount both the first piece and the second piece respectively to the forward and to the rear side regions of the vehicle, but also sufficient to mount the first and the second piece directly to each other, producing thereby a contiguous side bar for, and of proper length for, the vehicle.

The selected first piece can be of a length that does only approximately, and not exactly, span the forward side region of the vehicle, while the selected second piece can also be of a length that does only approximately, and not exactly, span the rearward side region of the vehicle. In this case the first and the second side pieces and the mounting hardware act, in concert, to bridge any gap, or to accommodate any overlap, between the first and the second piece and to permit, despite that both pieces are only of approximate length, that the pieces sill mount directly to each other and produce the contiguous side bar of proper length for the vehicle.

The selected first and second pieces are preferably hollow, and do fit and slide end-to-and within each other. This makes that, as combined and variably extended from each other, the two pieces will in combination exactly span the combined forward and rearward side regions of the vehicle, and will in combination be adjustable to the proper length of the vehicle.

Both the first and the second hollow pieces are preferably tubes.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a diagrammatic perspective view showing the preferred embodiment of an interlocking-tube variable-length two-piece vehicular side bar in accordance with the present invention, a forward region of the side bar to the front left in the figure as the side bar would be mounted to the left side of a vehicle (not shown).

FIG. 2 is a diagrammatic perspective view showing the preferred embodiment of an interlocking-tube variable-length two-piece vehicular side bar in accordance with the present invention previously seen in FIG. 1, a forward region of the side bar to the rear left in the figure as the side bar would again be mounted to the left side of a vehicle.

FIG. 3 is a diagrammatic perspective view showing a variant of the preferred embodiment of an interlocking-tube variable-length two-piece vehicular side bar in accordance with the present invention previously seen in FIGS. 1 and 2, a forward region of the side bar still to the left in the figure as the side bar would be mounted to the left side of a vehicle.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

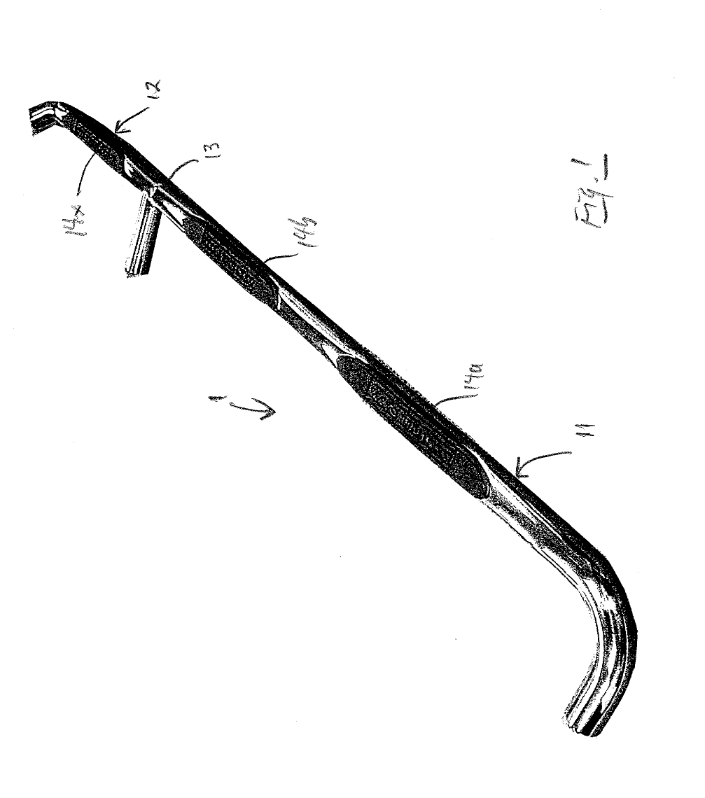

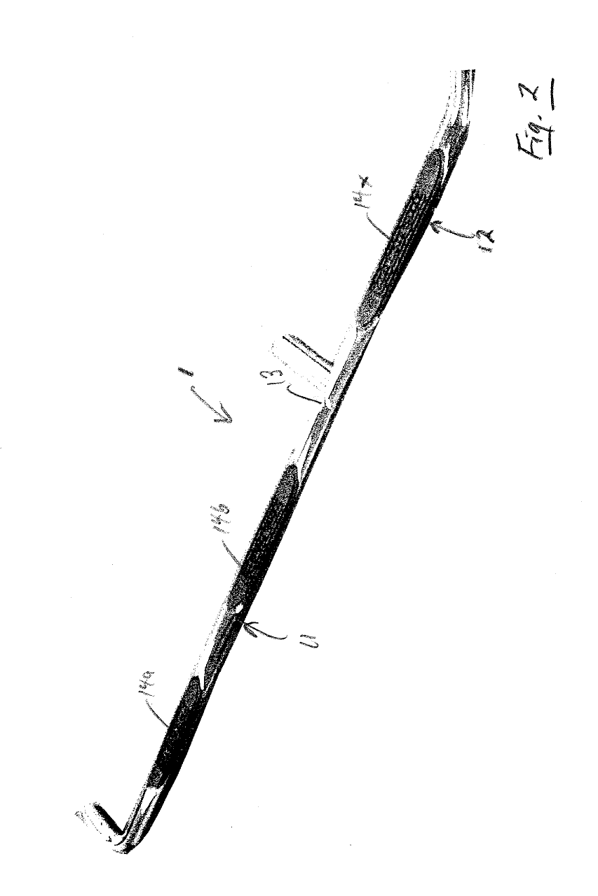

Diagrammatic perspective views of the preferred embodiment of an interlocking-tube variable-length two-piece vehicular side bar 1 in accordance with the present invention are shown in FIGS. 1 and 2. In each Figure a forward region, and portion, and member, and piece 11 of the side bar 1 is to the left. Likewise, in each Figure a rear region, and portion, and member, and piece 12 of the side bar 1 is to the right. FIGS. 1 and 2 illustrate a side bar 1 as would be mounted to a left side of a vehicle (not shown). A side bar mounted to the other (right) side of the vehicle is a mirror image.

The side bar 1 is preferably made from round steel tube, preferably 3″, external diameter stainless steel tube as is available from various steel companies. The cut, bent and flared pieces 11, 12 of the side bar 1 are welded together where applicable, it being understood that there is an un-welded union or seam 13, to be further discussed, between the forward piece 11 and the rear piece 12. The entire exterior surface of the side bar 1 in all its parts is commonly highly polished, and, especially if stainless steel is not used, may be chromed or otherwise finished with a powder coat or other durable finish.

The side bar 1 is mounted to the vehicle (not shown), most commonly in the vehicle's wheel wells, by brackets as are conventional, and as are substantially the same for all vehicles. Drilling is normally required for mounting, which proceeds by use of fasteners most commonly bolts and nuts.

The side bar 1 may be fashioned with or without one or more step surfaces 14a, 14b, . . . 14x at the top surfaces of the tubular members 11, 12.

The preferably tubular pieces 11, 12 (as illustrated) interlock to each other by action of an end of one tube, here illustrated to be rear piece 12, sliding into the open end of the other tube, here illustrated to be forward piece 11. This union 13 is tight, and strong. Moreover the pieces 11, 12 are preferably strongly held to each other by a fastener, normally a common bolt and nut (both not shown) of which typically only the head of the bolt is visible to the exterior of the side bar 1 in any case, in this only to the interior. With the bolt to the exterior, the nut is, of course, at the interior of the inside tube, or rear piece 11. It may be conveniently welded there, or, as permits slight movement along the longitudinal axis of the pieces 11, 12, maintained captive in a nut holder. Either the inside rear piece 12, or the outside front piece 11, or both, may optionally present at the location of their fastened connection by nut an bolt an elongate slot, normally but a few inches in length, that permits of a slight adjustment in the length of the combined pieces. Normally this (these) slot(s)—not shown—are not necessary, and, with judicious choice of the length of both tubular pieces 11, 12, a fit of exacting precision may be realized for most trucks without necessity of adjustment of overlap in the region of joint 13.

The vehicle side bar 11 may be adapted for a pickup truck (not shown) having a cab region and a bed region. In this case the forward interlocking piece 11 extends the along the cab region of the pickup truck while the rearward interlocking piece extends alongside a forward portion of bed region of the pickup truck in the area before the rear wheel well. The first piece 11 interlocks to the second piece 12 at union 13 which is substantially where the cab of the pickup truck meets the bed of the pickup truck.

It will be understood that, by virtue of the end region of the rear piece 12 sliding within an end region of the front piece 11 to a variable extent, the two pieces 11, 12 together extend when slidingly mated one to another for a variable distance along a side of the vehicle. The multiple-piece side bar 1 is thus adjustable in length.

The two-piece side bar 1 of the present invention is preferably delivered into service as a user-specified and user-installable kit. By use of the proper kit even an mechanically maladroit user may mount a side bar of exactingly proper length to and along a full side of a vehicle. In so doing, the forward piece 11 of the side bar 1 of course fits alongside a forward side region of the vehicle while the rear piece 11 of the same side bar 1 fits alongside a rear side region of the vehicle, both regions being between the vehicle's two same-side wheel wells.

The kit includes (i) the first piece 11 selected in accordance with the vehicle from among a plurality of first-type pieces of various lengths that are variously suitable to substantially span forward side regions of various different vehicles, (ii) the second piece 12, also selected in accordance with the vehicle, from among a plurality of second-type pieces of various lengths that are variously suitable to substantially span rear side regions of various different vehicles, and (iii) mounting brackets and 30 attaching hardware sufficient not only to mount both the first piece 11 and the second piece 12 respectively to the front and to the rear side regions of the vehicle, but also sufficient to mount the first piece 11 and the second piece 12 directly to each other, producing thereby a contiguous side bar for, and of proper length for, the vehicle.

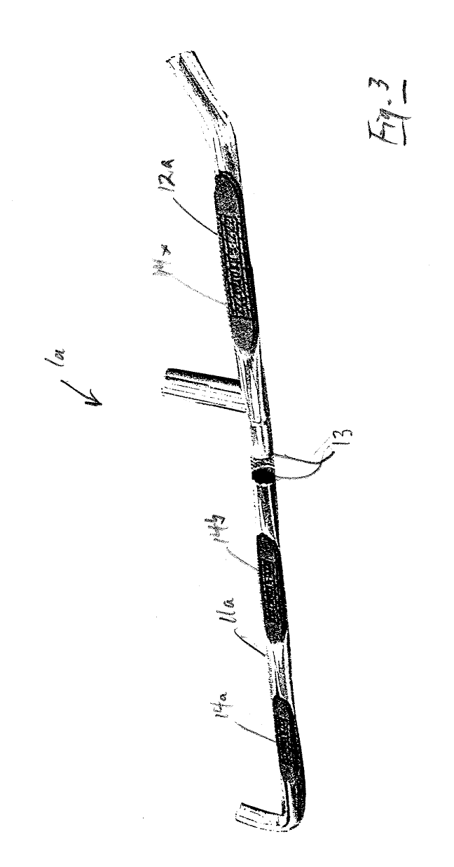

Pieces 11a, 12a that are each of different lengths than their counterpart pieces 11, 12 (shown in FIGS. 1 and 2) are shown in FIG. 3. These pieces 11a, 12a are also shown separated, before forming the union 13.

The selected first piece 11a can be of a length that does only approximately, and not exactly, span the front side region of the vehicle, while the selected second piece 12b can also be of a length that does only approximately, and not exactly, span the back side region of the vehicle. In this case the first piece 11a and the second piece 12a and their mounting hardware act, in concert, to bridge any gap, or accommodate any overlap, between the first and the second piece and to permit, despite that both pieces 11a, 12a are only of approximate length. These pieces 11a, 12a still mount directly to each other, and produce a contiguous side bar 1a of exactly proper length for the vehicle.

In all variants the selected first pieces 11, 11a and second pieces 12, 12a are hollow, and do fit and slide end-to-and within each other. This makes that, as combined and variably extended from each other, any two pieces 11, 12 or 11a, 12a will in combination exactly span the combined front and back side regions of the vehicle, and will in combination be adjustable to the proper length of the vehicle.

In accordance with the preceding explanation, variations and adaptations of the side bars 1, 1a in accordance with the present invention will suggest themselves to a practitioner of the mechanical arts. For example, the number of interlocking pieces could clearly easily be expanded to three or more. Furthermore, the pieces need not have the same external finish, or some could be equipped with step regions and some not (depending upon whether the side of the vehicle to which the side bar 1, 1a will be mounted offers a door opening, or not, at the corresponding position. (It will be understood that some crew, and extended, cab configurations of pick up trucks have rear doors on one side only.)

In accordance with these and other possible variations and adaptations of the present invention, the scope of the invention should be determined in accordance with the following claims, only, and not solely in accordance with that embodiment within which the invention has been taught.

What is claimed is:

1. A side bar for a vehicle comprising:
two or more interlocking pieces.

2. The vehicle side bar according to claim 1
wherein each of the interlocking pieces is tubular.

3. The vehicle side bar according to claim 2
wherein the tubular interlocking pieces so interlock by action of an end of one tube sliding into an end of another.

4. The vehicle side bar according to claim 1 adapted for a pickup truck having a cab region and a bed region
wherein a first interlocking piece extends the along the cab region of the pickup truck;
wherein a second interlocking piece extends the along the bed region of the pickup truck; and
wherein the first piece interlocks to the second piece where the cab of the pickup truck meets the bed of the pickup truck.

5. A side bar for a vehicle comprising:
two or more elongate hollow pieces that, by virtue of an end region of one piece sliding within an end region of another piece to a variable extent, extend when slidingly mated one to another for a variable distance along a side of the vehicle;
wherein the multiple-piece side bar is adjustable in length.

6. The vehicle side bar according to claim 2
wherein each of the two or more elongate hollow pieces is tubular.

7. A user-specified and user-installable kit for mounting a side bar of proper length to and along a full side of a vehicle having both a forward side region and a rear side region between two same-side wheel wells, the kit comprising:
a first piece selected in accordance with the vehicle from among a plurality of first-type pieces of various lengths that are variously suitable to substantially span forward side regions of various different vehicles;
a second piece, also selected in accordance with the vehicle, from among a plurality of second-type pieces of various lengths that are variously suitable to substantially span rear side regions of various different vehicles; and
mounting brackets and attaching hardware sufficient not only to mount both the first piece and the second piece respectively to the forward and the rear side regions of the vehicle, but which also serve to mount the first and the second piece directly to each other, producing thereby a contiguous side bar for, and of proper length for, the vehicle.

8. The side bar kit in accordance with claim 7 wherein the selected first piece is of a length that does only approximately, and not exactly, span the forward side region of the vehicle;
wherein the selected second piece is of a length that does only approximately, and not exactly, span the rearward side region of the vehicle; and
wherein the first and the second side pieces and the mounting hardware act, in concert, to bridge any gap, or accommodate any overlap, between the first and the second piece and permit, despite that both pieces are only of approximate length, that the pieces sill mount directly to each other and produce the contiguous side bar of proper length for the vehicle.

9. The side bar kit in accordance with claim 8
wherein the selected first and second pieces are hollow, and do fit and slide end-to-and within each other so that, as combined and variably extended from each other, they will in combination exactly span the combined forward and rearward side regions of the vehicle, and will in combination be adjustable to the proper length of the vehicle.

10. The side bar kit in accordance with claim 8 wherein the first and second hollow pieces comprise:
tubes.
